(19) United States
(12) Patent Application Publication
(10) Pub. No.: US 2014/0331845 A1
(43) Pub. Date: Nov. 13, 2014

(54) STABILIZATION DEVICE FOR A BLADE OF A SAW DEVICE

(71) Applicant: Reijo VILJANEN, Tampere (FI)

(72) Inventor: Reijo Viljanen, Tampere (FI)

(21) Appl. No.: 14/365,643

(22) PCT Filed: Dec. 14, 2012
(86) PCT No.: PCT/FI2012/000047

§ 371 Date: Jun. 16, 2014

(30) Foreign Application Priority Data
Dec. 14, 2011 (FI) U20110271

(51) Int. Cl. B27B 13/10; B27B 5/29; B27B 13/16

(52) U.S. Cl. CPC B27B 13/10; B27B 13/16; B27B 5/29
USPC 83/820; 83/469

(57) ABSTRACT

Stabilization device of the blade (1),(14) of a saw device with the help of which device the lateral movements which occur during the sawing of the blade (1) of a band sawing machine of a circular saw blade (14) at least at the location of the wood (9) to be sawed can be reduced. The equipment comprises at least magnetic devices (6, 7);(12) which are adjusted to be at a distance from each other and are located at the other side of the blade (1),(14) with the help of which magnetic devices one can form a magnetic flux (10) which runs through the area which is apt to the lateral movements of the blade (1),(14) between the mentioned magnetic devices.

Object of the invention is a stabilization device of a blade of a saw device with the help of which stabilization device lateral movements of a blade of a band sawing machine or a circular saw blade during the sawing can be reduced at the location of the wood to be sawed.

Controlling of the blade of a band sawing machine and a blade of a circular saw with the help of magnets is previously known from the publication WO 00/47378 in which the blade is aimed to be kept at the aimed sawing line with the help of the controlling. The controlling is made by adjusting magnetizing forces. If the blade is at the aimed line, no magnetic forces are directed to the blade. The position of the blade is measured all the time with the help of sensors. Also the tension of the blade to the sawing line with the help of magnets is also known from the publication WO 2007/014979. In this case the magnetizing forces are being activated all the time by tightening the blade in order to make it stay in the desired, deviated position.

The operating principle of the known magnetic devices is the fact that the metallic blade is aimed to be pulled or pushed with the help of them precisely at the location of the magnet. Purposely the magnetic flux is not being directed anywhere further at this location. When one wants to pull the blade with the help of a magnet, the both poles of the magnet (such as a horseshoe magnet) are located next to each other close to the blade and the flux runs in the blade only from one pole location of the magnet to another. In these known solutions the position of the blade is measured and when the position is changing away from the desired line, one aims to return the blade back to the desired line with the help of magnetizing force.

With the help of stabilization device of the blade according to the invention one aims to create stiffness to the blade against bendings so that the blade would be able to maintain its straight form during the sawing situation even though sideways interference forces might be directed to it. It is characteristic of the stabilization device according to the invention that the equipment comprises at least magnetic devices which are adjusted at a distance from each other and are located at the other side of the blade with the help of which magnetic devices a magnetic flux, which runs through the area which is apt to the lateral movements of the blade, can be formed between the mentioned magnetic devices.

The advantage of the invention is an easy controlling of the magnetic devices because with the help of them the blade is not controlled to stay at the sawing line according to the information given by the position sensors but only the magnetic flux, which runs through the area being to the lot which belongs to the blade, is being maintained. One does not aim to move the blade anywhere. The magnetic flux which runs through the mentioned area being located in the blade stiffens this area to stay planar.

In the following the invention is described more detailed by referring to the accompanying drawings in which

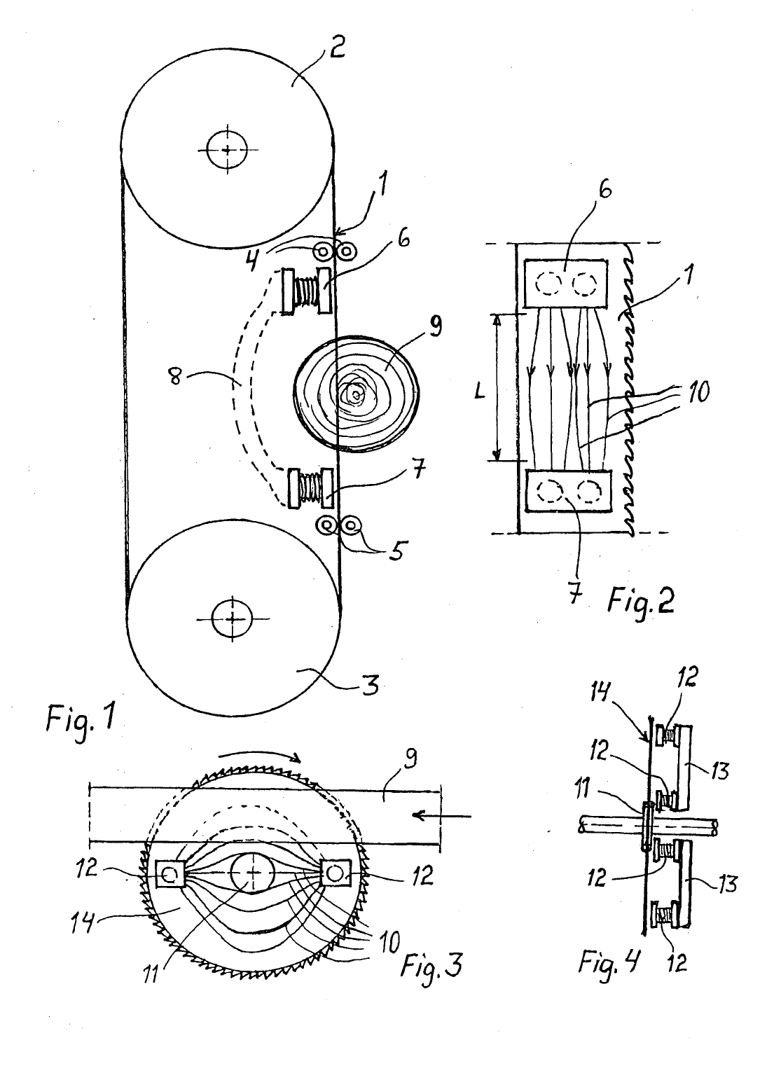

FIG. 1 shows a band sawing machine to which a stabilization device according to the invention has been joined.

FIG. 2 shows a stabilization device in combination with the blade seen from the side of the blade.

FIG. 3 shows a stabilization device in a circular saw seen as a side view.

FIG. 4 shows another stabilization device in the circular saw seen in the direction of the blade.

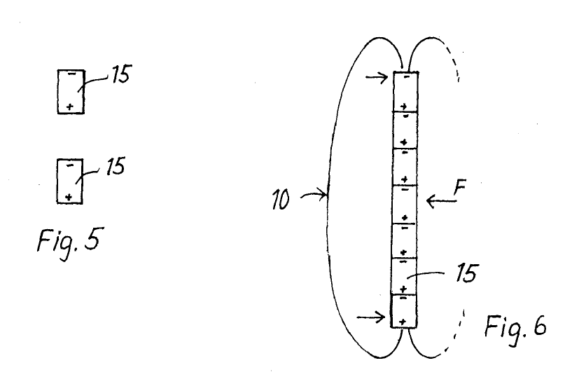

FIG. 5 shows permanent magnets.

FIG. 6 shows a stiff pile of permanent magnets.

In the FIG. 1 there is a band sawing machine which comprises a blade 1 and sheaves 2 and 3 through which the blade moves. Magnets 6 and 7 are located at the location of the blade 1 underneath and above of the wood 9 to be sawed which magnets form a magnetic flux which runs through the blade 1 to that area of the blade 1 which area is located between the magnets 6 and 7. It is advantageous to have another pair of similar magnets at the other side of the blade 1 being located symmetrically in relation to the magnets 6 and 7 which magnets for their part further reinforce the flux 10 (FIG. 2) formed by the magnets 6 and 7. When the magnets are located at both sides of the blade 1 and have the similar strength, the magnets do not move the blade 1 aside from the chosen sawing line. Controllers known as such, such as gliding elements or rolls 4 and 5 keep the position of the blade 1 in its place. The magnets 6 and 7 are combined at their back parts with the help of a piece of iron 8 in order to form a closed and strong flux loop. The magnets 6 and 7 are electric magnets or permanent magnets and both of these types can be switched on and off.

FIG. 2 shows the flux directions 10 to the blade 1 created by the magnets 6 and 7. Several magnets which are to be adjusted to have the same direction regarding their polarity can be located side by side in the magnets 6 and 7. A relatively thin, planar blade 1 stiffens against lateral forces in the area L which is between the magnets 6 and 7 in which area the magnetic fluxes 10 run. The blade 1 stays at the location of the wood to be sawed 9 at the sawing line meant for it better this way than without the magnetic flux 10.

FIG. 3 shows the stabilization magnets 12 when they are in the combination with the circular saw blade 11. The magnetic fluxes 10 run in the blade 14 from one magnet to another by stiffening the blade 14. In the FIG. 4 the magnets 12 are located in such a way that the magnetic fluxes run from the outer edge of the blade 14 close to the pole. A piece of iron 13 combines the magnets at the back side in which case a closed cycle can be arranged for the magnetic flux and the magnetic flux can be organized to be stronger. Also in the case of the circular saw blade 14 the blade 14 becomes stable and stiffens due to the magnetic flux 10. The magnets 12 which are electric or permanent magnets are most advantageously located at both sides of the circular saw blade 14.

The stiffening of the blades 1 and 14 occurs when the elementary magnets, which belong to the blade material,, are being directed in the direction of the flux lines of the magnetic flux 10 to be created. The blade material must be made of ferromagnetic material. The stiffening effect of the magnetic flux 10 is shown in the FIGS. 5 and 6 as a principled presentation. The permanent magnets 15 are piled on top of each other so that they form an elongated bar. The permanent magnets 15 create a magnetic flux 10 which runs through the bar and closes through the flux which returns outside the bar. The magnetic fluxes 10 stiffen the bar so that lateral force F is needed in order to break the stiffness of the bar.

1. Stabilization device of the blade (1),(14) of a saw device with the help of which device the lateral movements which occur during the sawing of the blade (1) of a band sawing machine of a circular saw blade (14) at least at the location of the wood (9) to be sawed can be reduced, characterized in that the equipment comprises at least magnetic devices (6, 7);(12) which are adjusted to be at a distance from each other and are located at the other side of the blade (1),(14) with the help of which magnetic devices one can form a magnetic flux (10) which runs through the area which is apt to the lateral movements of the blade (1),(14) between the mentioned magnetic devices.

2. Stabilization device according to the claim 1, characterized in that in the blade (1) of the band sawing machine the area of the magnetic flux (10) is adjusted in the direction of the blade (1) to be so long that the blade part (L) performing the sawing stays inside the mentioned area.

3. Stabilization device according to the claim 1, characterized in that the magnetic fluxes (10) are adjusted to run essentially covering the width of the blade (1).

4. Stabilization device according to the claim 1, characterized in that the magnetic fluxes (10) are adjusted to run from one edge part of the blade (14) of the circular saw to another edge part being located at a distance.

5. Stabilization device according to the claim 1, characterized in that the magnetic fluxes (10) are adjusted to run from one edge part of the blade (14) of the circular saw to the area of the center flange (11) of the blade (14) of the circular saw.
